(19) United States
(12) Patent Application Publication
(10) Pub. No.: US 2025/0209326 A1
(43) Pub. Date: Jun. 26, 2025

(54) Method and System for Network of Generative AI Agents Representing Entities and Persons

(71) Applicant: Vijay Madisetti, Alpharetta, GA (US)

(72) Inventors: Vijay Madisetti, Alpharetta, GA (US); Arshdeep Bahga, Chandigarh (IN)

(73) Assignee: Vijay Madisetti, Alpharetta, GA (US)

(21) Appl. No.: 19/059,541

(22) Filed: Feb. 21, 2025

Related U.S. Application Data
(60) Provisional application No. 63/613,777, filed on Dec. 22, 2023.

(51) Int. Cl. G06N 3/08; G06N 3/045

(52) U.S. Cl. CPC G06N 3/08; G06N 3/045

(57) ABSTRACT

A system and method of creating and operating LLM agent AI-powered digital twins including collecting multimodal data streams from user devices, processing the multimodal data through specialized pipelines, generating specialized AI models for language, audio, video, and image processing, and performing external tasks in the real-world, using tools, combining the specialized models into an ensemble architecture, operating the ensemble model in a tethered mode with user oversight, continuously updating the model based on user feedback and interaction patterns, validating model performance against predetermined thresholds, implementing autonomous operation guardrails, and transitioning to autonomous untethered operation upon meeting performance criteria.

### RELATED APPLICATIONS

This application claims priority under 35 U.S.C. §119(e) of U.S. Provisional Patent Application Ser. No. 63/613,777 (Attorney Docket No. 3026.00167) filed on Dec. 22, 2023 and titled Atman-Network of Generative AI Entities Representing Entities and Persons. The content of this application is incorporated herein by reference.

### FIELD OF THE INVENTION

The present invention primarily relates to artificial intelligence and large language models (LLMs) agents for generative AI applications, and more particularly to systems and methods for creating efficient and practical AI-powered digital twins of individuals or entities using LLMs agents.

### BACKGROUND

Large Language Models (LLMs) and agents are generative Artificial Intelligence (AI) models which are trained on vast amounts of data and can perform complex language processing tasks with multimodal inputs including text, tools, audio, images, and video. LLMs and agents can capture intricate patterns in human communication and produce output that closely resembles human interaction across multiple modalities. The high-level goal of an LLM is to predict and generate content that appropriately continues or responds to a given context or prompt.

Recent advances in LLM agent technology have enabled increasingly sophisticated applications and use of tools beyond simple text generation. These include personality modeling, behavioral prediction, and influence analysis. However, current implementations are limited in their ability to create comprehensive digital representations of specific individuals or to systematically analyze human psychological and behavioral vulnerabilities for targeted interaction.

Existing digital preservation solutions focus primarily on static content like documents, photos, and videos rather than creating dynamic, interactive representations of individuals. While some solutions attempt to create chatbots or avatars based on an individual's data, they typically fail to capture a broader (not necessarily all) range of personality traits, knowledge, and/or behavioral patterns that make each person unique and also lack the authentication and authorization mechanisms necessary for efficient operation, and further do not use the external facing tools available to LLM agents and the ability of agents to work closely with other LLM agents.

LLM Agents offer unique capabilities which can be leveraged for creating high-fidelity digital twins of individuals or entities. By combining advanced language modeling with multimodal processing and specialized training approaches, LLM Agents can enable new paradigms for digital preservation.

This background information is provided to reveal information believed by the applicant to be of possible relevance to the present invention. No admission is necessarily intended, nor should it be construed that any of the preceding information constitutes prior art against the present invention.

### SUMMARY OF THE INVENTION

With the above in mind, embodiments of the present invention are directed to a system and associated methods for creating AI-powered digital twins of individuals using large language models (LLM) agents or entities.

In one embodiment, the present invention comprises a system for capturing

an individual's digital footprint including writings, conversations, behaviors, and knowledge over their lifetime to create an AI digital twin or avatar that can emulate their communication patterns and decision-making processes. The system is configured to assimilate diverse data streams including, but not limited to, written communications, verbal interactions, computational device interactions, financial transactions, travel patterns, and behavioral data. These multimodal data streams are processed and utilized to fine-tune specialized language models that can generate responses and behaviors characteristic of the represented individual. This system, referred to as ATMAN (Adaptive Twin Model for Assimilating Neural-knowledge), utilizes specialized language models fine-tuned on personal data to preserve and recreate an individual's unique traits. The term “ATMAN” as used herein refers to “Adaptive Twin Model for Assimilating Neural-knowledge,” wherein:

“Adaptive” refers to the system's capability to dynamically update digital twin models based on continuous data acquisition;

“Twin” denotes the digital representation utilizing an LLM agent corresponding to a specific individual; “Model” encompasses the artificial intelligence and deep learning frameworks employed;

“Assimilating” describes the process of incorporating and synthesizing user data; and

“Neural-knowledge” refers to the neural network-based processing mechanisms for preserving and replicating human knowledge and behavior patterns.

In another embodiment, the present invention comprises a network of artificial intelligence models, specifically fine-tuned large language models (LLMs), and LLM Agents, configured to create persistent digital representations of individuals. These digital representations, hereinafter referred to as digital twins or avatars, may be created and maintained either during an individual's lifetime or posthumously, subject to appropriate authorization and consent protocols. LLM agents are specially of interest as they can interact with the real-world using tools in our embodiments and invention.

In certain embodiments, the digital twins or avatars are configured to interact with living individuals and also the real-world through various communication channels, tools (such as web search or web-based applications) and social networking platforms in a manner consistent with the represented individual's communication patterns. The system further enables the creation of composite digital twins representing groups of individuals or entities, such as family units, corporate boards, or administrative bodies, thereby preserving collective knowledge. The system incorporates reasoning and decision-making patterns and involves creation of agents that can mimic the activities of the modeled individual, using tools and other LLMs for enacting their actions. These digital twins or avatars are not just capable of interacting with other avatars and living individuals (non-avatars) but are also capable of taking actions in the real world using tools, such as web search tools, banking tools, and other actions that are authenticated by them. They can also make decisions and reason based on their personality and carry out actions.

In another embodiment, the present invention comprises a system for operating digital twins (LLM agents specially trained to interact with the physical real-world on behalf of a modeled individual) in a tethered mode, wherein the digital twin maintains a bidirectional relationship with a living individual. The system implements a multi-stage decision-making framework that processes all actions through an analysis module configured to perform pattern matching against learned behaviors, analyze historical context, and conduct ethical evaluation of proposed actions. The system comprises a risk assessment module that automatically approves actions falling within predetermined low-risk thresholds while routing higher-risk actions for explicit human approval. The system further includes an action execution layer equipped with authentication modules for interfacing with external systems including communication platforms, smart home systems, banking systems, property management tools, and other external tools. All executed actions are recorded through a comprehensive logging system that maintains detailed audit trails. The system implements a learning and synchronization subsystem that processes continuous, periodic, or occasional data streams comprising behavior patterns, preferences, knowledge base updates, and decision patterns, enabling real-time adaptation of the digital twin's capabilities in accordance with the living individual's characteristics and interaction patterns and behavior with respect to the external real-world that the individual lives in. The LLM agent, or Atman, as well call them may carry out many of the tasks performed by the individual on their behalf, including social interaction, purchases of goods and materials, participation in work related functions on behalf of the modeled individual (e.g., writing code for the individual on work or professional projects), and therefore magnifying their productivity and influence. Teams of Atmans or LLM agents may be also created to model an individual, where the teams can replicate or multiply this effect or may partition the functionality of the modeled individual in different spheres of specialization, where on LLM agent is used for social interaction, and another for coding work on behalf of the individual.

.

In another embodiment, the present invention comprises a system for operating digital twins (based on LLM agents using external tools) in an autonomous untethered mode, wherein the digital twin functions independently while maintaining alignment with the original individual's decision-making patterns and preferences. The system implements enhanced safety protocols including a multi-stage evaluation process for all actions and requests, comprising pattern matching against established behavioral baselines, historical context analysis, and rigorous ethical evaluation of all proposed actions. The system includes a specialized risk assessment module that implements threshold-based evaluation, automatically approving actions within strictly defined acceptable bounds while rejecting higher-risk actions that exceed predetermined safety thresholds. The system further comprises an action execution layer with enhanced authentication and verification mechanisms for interacting with external systems, implementing comprehensive logging and monitoring capabilities that maintain detailed records of all autonomous operations. The system includes feedback processing mechanisms that enable continuous refinement and adjustment of operational parameters based on execution outcomes, maintaining alignment with established behavioral patterns while operating independently.

In yet another embodiment, the present invention comprises a system for managing the transition between tethered and untethered operational modes, implementing a gradual progression framework that systematically evaluates operational readiness across multiple dimensions. The system comprises performance monitoring modules that track decision-making accuracy, risk assessment precision, and execution success rates across various interaction categories. The system implements a protocol for progressive automation for gradually increasing the autonomous decision-making for low-risk actions. The system includes sophisticated pattern analysis modules that examine user approval histories to develop refined risk assessment criteria and decision-making frameworks. The system further comprises enhanced safety protocol implementation mechanisms that systematically deploy additional operational guardrails, verification checks, and monitoring capabilities as autonomous authority increases. The transition management system maintains comprehensive logging and analysis capabilities throughout the progression, enabling detailed performance evaluation.

### BRIEF DESCRIPTION OF THE DRAWINGS

FIG. 1 is an illustration of the ATMAN system architecture, according to an embodiment of the present invention.

FIG. 2 is an illustration of the data collection and storage processes in the ATMAN system according to an embodiment of the present invention.

FIG. 3 is an illustration of the model training process in the ATMAN system according to an embodiment of the present invention.

FIG. 4 is an illustration of the operational flow of the ATMAN system during query processing and response generation, according to an embodiment of the present invention.

FIG. 5 is an illustration of an ATMAN digital twin operating as active agent in tethered mode, according to an embodiment of the present invention.

FIG. 6 is an illustration of an ATMAN digital twin operating as active agent in an autonomous untethered mode, according to an embodiment of the present invention.

FIG. 7 is an illustration of the process for transition from tethered to autonomous untethered mode, according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled people having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

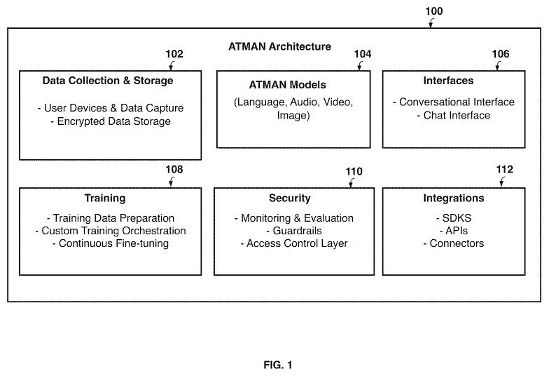

Referring now to FIG. 1 is an illustration of the ATMAN system architecture, is described in more detail. The ATMAN architecture 100 comprises subsystems including Data Collection and Storage 102, ATMAN Models 104, Interfaces 106, Training 108, Security 110, and Integrations 112.

The Data Collection and Storage subsystem 102 comprises various data sources, such as mobile devices, computers, wearables, and connected vehicles, from which multimodal data of a user and his or her environment, including their colleagues or associates, is collected. These devices implement secure client software for recording activities including text conversations, audio recordings, video footage, photos, news reports, and behavioral logs with or without explicit user consent. The collected data flows into a data capture pipeline, which processes incoming data streams through specialized APIs and connectors. This pipeline implements real-time processing for different data types, converting raw inputs into standardized formats suitable for downstream processing. The processed data is then securely stored in an encrypted data storage layer comprised by the Data Collection and Storage subsystem 102 which comprises distributed cloud datastores that implement end-to-end encryption, role-based access controls, data pseudonymization, and comprehensive audit logging capabilities. This layer serves as the secure foundation for all subsequent training and model development processes.

The Training subsystem 108 receives data from the Data Collection and Storage subsystem 102 and performs preprocessing functions including data cleaning, normalization, and format standardization across all modalities. This subsystem generates feature embeddings and compiles validated training sets, applying data augmentation techniques where appropriate to enhance model performance. The prepared data then flows into a custom training orchestration module comprised by the Training subsystem 108 which manages the creation of personalized AI models. The Training subsystem 108 continuously monitors model performance and manages versioning and deployment processes.

The ATMAN Models 104 subsystem comprises a plurality of models for interacting with data across a plurality of modalities, such as:
Language Model: Contextual large language models and LLM agents which are fine-tuned on the user's writings, texts and verbal conversations to emulate their writing patterns, vocabulary, personality quirks, areas of interests, for instance, and can use specialized tools that allow them to interact with the external world, to carry out tasks, such as write code, play music, or carry out purchases on behalf of the modeled user.
Audio Model: Self-supervised models which are trained on the vocal characteristics to synthesize new speech in the user's voice using sample scripts or generated texts.
Video Model: Generative adversarial networks which clone facial mannerisms, gestures and expressions from video footage into a simulated avatar that renders dynamically lip-synced to the speech model outputs.
Image Model: Memory-augmented networks which perform facial recognition on personal photos and metadata to describe visual scenes and answer questions on past events or recognize relatives.
   Other models operable to interact with data in other modalities as may be known in the art are contemplated and included within the scope of the invention.

The Interfaces subsystem 106 implements multiple channels for interaction with ATMAN digital twins. The Interfaces subsystem 106 comprises a conversational interface, which comprises a natural language processing engine enabling human-like text interactions with real-time response generation using ensemble model outputs. The system maintains context across conversation sessions while supporting multiple languages for global accessibility. Advanced features include emotion detection with appropriate response modulation and configurable personality parameters that match the original individual's characteristics. The Interface subsystem 106 further comprises a chat interface which provides asynchronous message handling for text-based communications, maintaining message history and context threading throughout interactions. The chat interface supports rich media sharing including images and documents, while integrating with popular messaging platforms. Users can access custom formatting and styling options, with all communications protected by message encryption and secure transmission protocols.

The Security subsystem 110 implements comprehensive protection mechanisms across all layers of the LLM agent architecture. The Security subsystem 110 comprises a monitoring & evaluation module provides real-time activity monitoring for unusual patterns, coupled with automated threat detection and response capabilities. The module continuously tracks performance metrics and analyzes system behavior while ensuring compliance with regulatory requirements through comprehensive audit logging of all operations. The Security subsystem 110 further comprises a guardrails module that implements content filtering for inappropriate or harmful outputs, along with rate limiting to prevent system abuse. This includes robust input validation and sanitization, output verification against ethical guidelines, behavioral constraints on model responses, and emergency shutdown protocols when necessary. The Security subsystem 110 further comprises an access control module that enforces role-based access control (RBAC) with multi-factor authentication and session management.

The Integration subsystem 112 facilitates connectivity with external systems and platforms through multiple mechanisms. The Integration subsystem 112 comprises one or more software development kits (SDKs) which are provided for major programming languages and LLM Agents, along with documentation, code examples, and testing frameworks. Developers can access sample applications and reference implementations, along with performance optimization guidelines. The Integration subsystem 112 further comprises APIs and RESTful endpoints, which are provided for core functionalities, including webhooks for event-driven integration. The Integration subsystem 112 further comprises a connectors module that offers pre-built integrations with popular platforms and social networks, use of external tools, alongside enterprise system integrations. The connectors module includes a custom connector development framework and implements data transformation pipelines with protocol adapters for various communication standards.

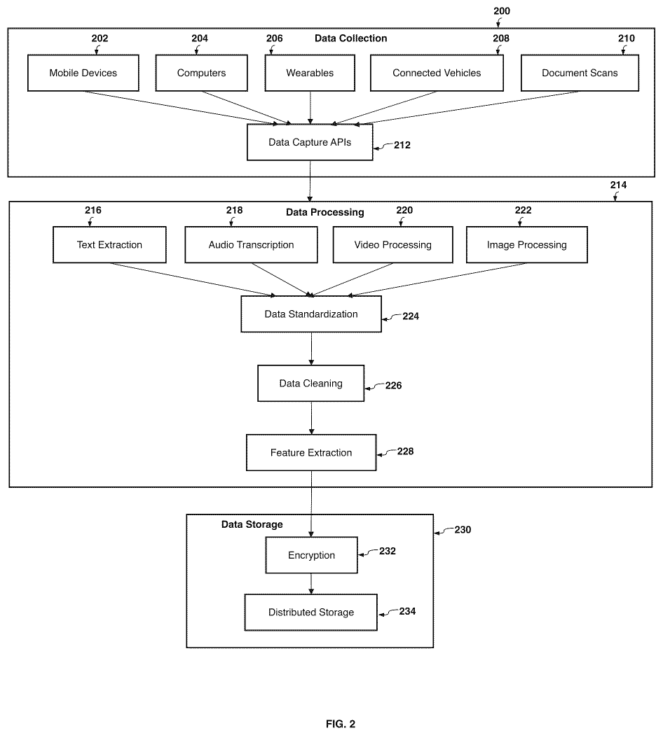

Referring now to FIG. 2, an illustration of the data collection and storage processes in the ATMAN system is described in detail. The Data Collection subsystem 200 comprises multiple data capture endpoints, including (but not limited to) sources such as Mobile Devices 202, Computers 204, Wearables 206, Connected Vehicles 208, and Document Scans 210. These devices implement secure client software for recording user activities across various data modalities. All endpoints interface with one or more centralized Data Capture APIs 212 that standardize the ingestion of heterogeneous data streams while maintaining data integrity and security compliance.

The Data Processing subsystem 214 implements a multi-stage pipeline for transforming raw input data into machine-learning-ready formats. The pipeline begins with parallel processing streams for Text Extraction 216, Audio Transcription 218, Video Processing 220, and Image Processing 222. These streams feed into a sequential processing chain comprising Data Standardization 224, Data Cleaning 226, and Feature Extraction stages 228. Each stage 224, 226, 228 implements specialized algorithms for improving data quality and extracting relevant features for model training.

The Data Storage subsystem 230 implements a secure distributed architecture for storing processed user data. This subsystem includes an Encryption module 232 for encrypting the processed data received from the Data Processing subsystem 214 and Distributed Storage 234 for storing the encrypted processed data.

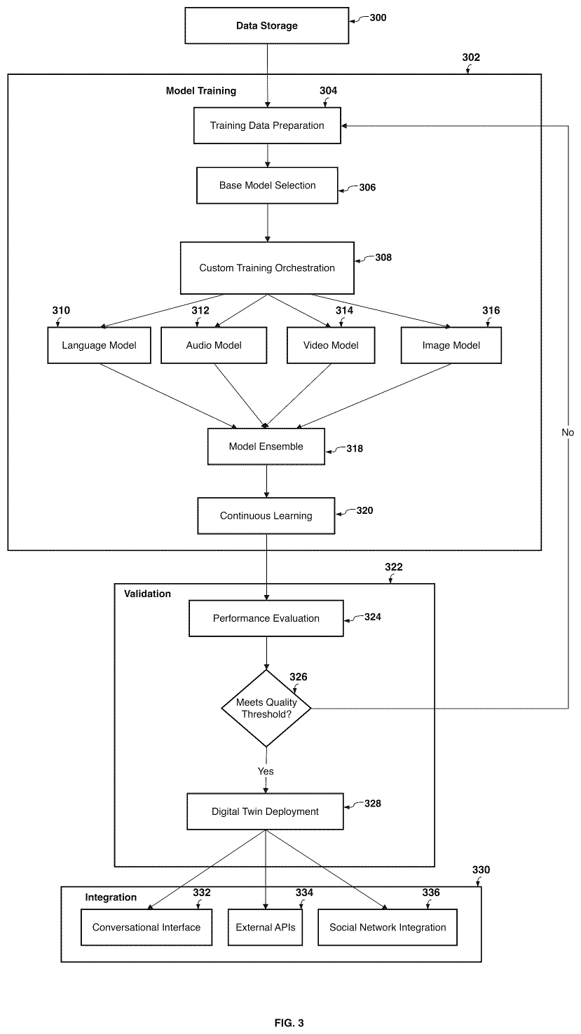

Referring now to FIG. 3, an illustration of the model training process in the ATMAN system is described in detail. An LLM Agent Model Training subsystem 302 orchestrates the creation and continuous improvement of the digital twin models. The training pipeline begins with Training Data Preparation 304, which takes data input from the Data Storage subsystem 300 and feeds the data input into Base Model Selection 306 and Custom Training Orchestration 308 modules. The Base Model Selection 306 module selects a base model from which a specialized model will be trained, and the Custom Training Orchestration 308 module coordinates the training of the selected base model responsive to the data modality for the specialized model. In the present embodiment, specialized training is done for four model types: Language Model 310, Audio Model 312, Video Model 314, and Image Model 316. It is contemplated and included within the scope of the invention that other modalities may be trained for. These models are combined through a Model Ensemble architecture 318 that implements Continuous Learning capabilities 320. The models may also work together to carry out external tasks in the real-world, and the training may include such activities.

A Validation subsystem 322 implements quality control mechanisms through performance evaluation of trained models. The Validation subsystem 322 comprises a Quality Threshold decision point 326 where it is determined whether models meet deployment criteria, routing failed models back to Training Data Preparation 304 and passing successful models to Digital Twin Deployment 328.

An Integration subsystem 330 provides interfaces for deploying and accessing digital twins through multiple channels. These include a Conversational Interface 332 for direct user interaction, External APIs 334 for third-party integration, and Social Network Integration 336 for broader platform connectivity.

The system implements a feedback loop architecture where validation results influence future training iterations, enabling continuous improvement of digital twin fidelity. Each subsystem 302, 322, 330 implements appropriate security and privacy controls, ensuring user data protection throughout the pipeline. The modular architecture allows for future expansion and enhancement of individual components while maintaining system integrity.

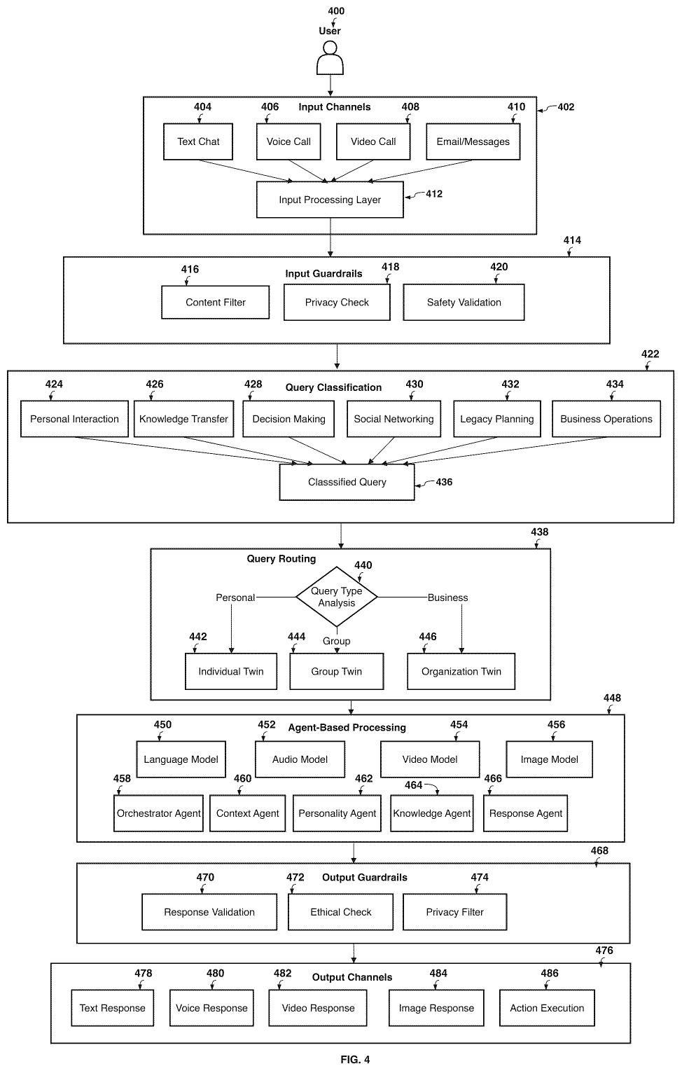

Referring now to FIG. 4, an illustration of the operational flow of the ATMAN system during query processing and response generation, is described in more detail. The system implements a multi-stage pipeline comprising input channels, input guardrails, query classification, query routing, agent-based processing, output guardrails and output channels.

The system begins with a User 400 sending a query through Input Channels 402 which accepts multiple input modalities, including, but not limited to, textual input 404, voice communications 406, video streams 408, and electronic mail/messages 410. The input is processed through an Input Processing Layer 412 and then fed to an Input Guardrails module 414. The Input Guardrails module 414 implements multiple checks including content filtering 416, privacy check 418, and safety validation 420, which may be performed in a series and/or in parallel, producing a validated query.

The validated query is then processed by a Query Classification module 422 which categorizes the query as a query type, producing a classified query 436, which may conform to one or more predetermined query types, including, but not limited to, personal interaction requests 424, knowledge transfer inquiries 426, decision-making assistance 428, social networking engagement 430, legacy planning operations 432, and business operational queries 434. These query types are exemplary only and any query type as may be known in the art is contemplated and included within the scope of the invention.

The classified query 436 is then directed to a Query Routing module 438 that performs a query type analysis at step 440 to determine the appropriate digital twin type for processing the request. The routing module directs queries to one of a plurality of primary twin categories: Individual Twin 442, Group Twin 444, or Organization Twin 446, based on the query characteristics and required response type. It is contemplated and included within the scope of the invention that other twin types may be comprised by the Query Routing module 438.

The query is then processed by an Agent-based Processing stage 448 comprising multiple specialized artificial intelligence agents that use one or more specialized models including, but not limited to, a language model 450, an audio model 452, a video model 454, and an image model 456. The Agent-based Processing Layer 412 includes:

an Orchestrator Agent 458 that coordinates the overall response generation process;

a Context Agent 460 that maintains conversational context and historical interaction data;

a Personality Agent 462 that ensures response consistency with the digital twin's characteristics;

a Knowledge Agent 464 that manages information retrieval and knowledge application; and

a Response Agent 466 that synthesizes the final output.

Prior to delivery, all generated responses undergo a security validation through Output Guardrails 468, which implements a response validation against predetermined quality metrics 470, an ethical compliance verification 472, and privacy protection filtering 474, resulting in approved responses.

The approved responses are then transmitted through appropriate Output Channels 476, which include one or more of text-based responses 478, synthesized voice communications 480, video outputs 482, image outputs 484, or executable actions 486, depending on the original query type/modality and user preferences, using external tools, for example, as LLM agents may do, and coordinating with other LLM agents.

The system maintains comprehensive logging and monitoring throughout the operational flow to ensure proper functioning and enable performance optimization. The modular architecture enables independent scaling and updating of individual components while maintaining overall system integrity and security. The entire architecture is designed with privacy and security as fundamental principles, implementing comprehensive controls at each layer to protect user data while enabling the creation of highly personalized digital twins. The system maintains strict isolation between different users' data and models, ensuring that personal information remains protected throughout the training and deployment process.

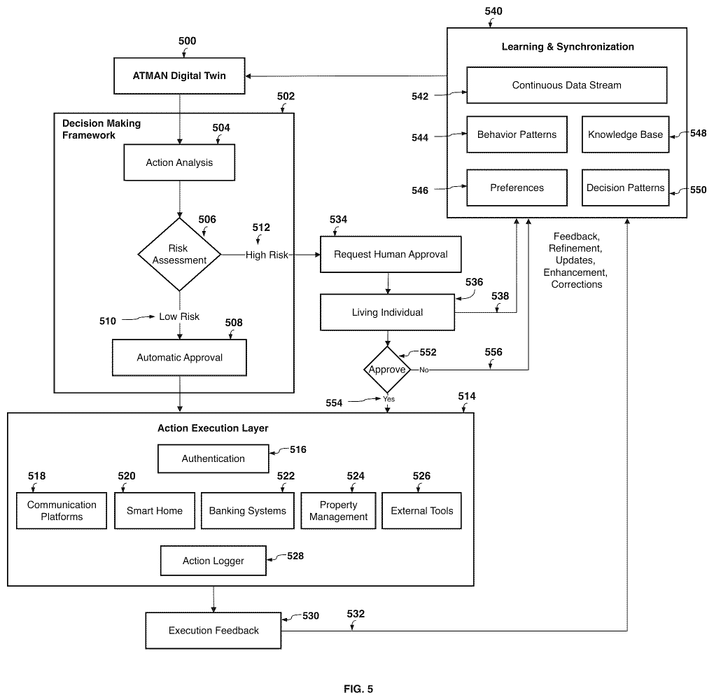

Referring now to FIG. 5, an illustration of an ATMAN digital twin operating as active agent in a tethered mode, is described in more detail. In the tethered mode, a bidirectional relationship between exists a living individual 536 and their corresponding ATMAN digital twin 500, encompassing multiple operational subsystems working in concert. A Decision Making Framework 502 implements a multi-stage evaluation process for all actions and requests. This Framework 502 comprises an Action Analysis module 504 that processes incoming events or requests. The Action Analysis module 504 performs a multi-stage analysis comprising pattern matching to correlate current situations with learned behaviors, analyzing the historical behavior to provides additional context based on past actions and decisions, and performing an ethical evaluation to ensure all proposed actions align with predetermined ethical constraints. The actions and requests are then routed to a Risk Assessment module 506 which implements threshold-based evaluation to automatically approve actions 508 within acceptable bounds (low-risk 510) while routing higher-risk actions 512 (including use of external tools) for human approval 534.

An Action Execution Layer 514 manages the implementation of approved actions through multiple specialized modules. An Authentication module 516 comprised by the Action Execution Layer 514 verifies and authorizes access to various external systems, including, but not limited to, Communication Platforms 518, Smart Home 520, Banking Systems 522, Property Management 524, and External Tools 526. All executed actions are recorded through an Action Logger module 528, maintaining comprehensive audit trails of system operations.

The Execution Feedback 530 is sent to a Learning & Synchronization subsystem 540. This subsystem processes multiple data categories including, but not limited to, behavior patterns 544, preferences 546, knowledge base 548, and decision patterns 550. For high-risk actions 512, a human approval is requested at step 534. Actions approved by the living individual 536 at step 552 are routed to the Action Execution Layer 514. In this way, paths from both automatic approval 508 and human approval 552 converge at the Action Execution Layer 514, ensuring appropriate oversight of all twin-initiated activities.

Each execution path generates feedback (Execution Feedback 530) that is processed through the Learning & Synchronization subsystem 540. The continuous data stream 542 enables real-time learning and adaptation of the digital twin's capabilities in accordance with the living individual's characteristics. This subsystem 540 enables direct feedback transmission, behavioral refinement, preference updates, knowledge enhancement, and decision pattern correction. The living individual 536 maintains active participation in the development of the ATMAN digital twin 500 and its use of external tools through multiple feedback channels, ensuring alignment with desired operational parameters.

The tethered mode architecture implements comprehensive logging and monitoring throughout the operational flow, enabling performance optimization while maintaining security compliance. The system maintains strict isolation between different users' data and models, ensuring that personal information remains protected throughout the training and deployment process.

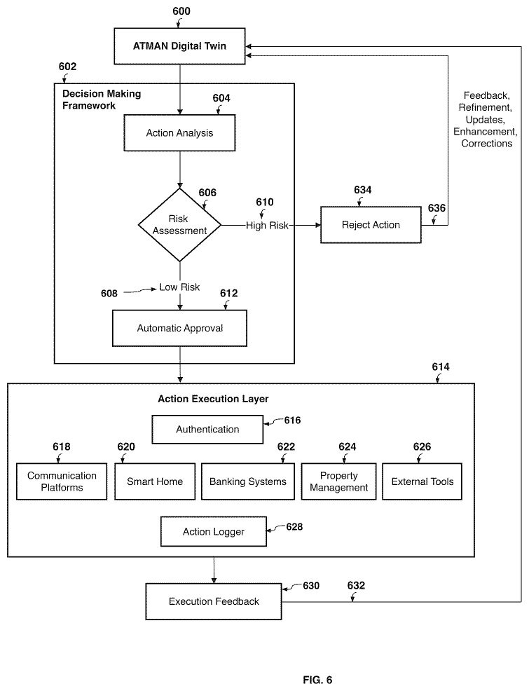

Referring now to FIG. 6, an illustration of an ATMAN digital twin operating as active LLM agent in an autonomous untethered mode, is described in more detail. The figure illustrates the autonomous operation of the ATMAN digital twin 600 following transition from tethered mode, encompassing multiple subsystems and use of external tools that ensure responsible and secure operation without direct oversight from the original individual.

The Decision Making Framework 602 implements a multi-stage evaluation process for all actions and requests. This framework comprises an Action Analysis module 604 that processes incoming events or requests. The Action Analysis module 604 performs a multi-stage analysis comprising pattern matching to correlate current situations with learned behaviors, analyzing the historical behavior to provides additional context based on past actions, including use of tools, and decisions, and performing an ethical evaluation to ensure all proposed actions align with predetermined ethical constraints. The actions and requests are then routed to a Risk Assessment module 606 which implements threshold-based evaluation to automatically approve actions 612 within acceptable bounds (low-risk 608) while rejecting higher-risk actions at step 634. The rejected actions are sent back to the ATMAN digital twin 600 for refinement, updates, enhancements, and corrections.

An Action Execution Layer 614 manages the implementation of approved actions through multiple specialized modules. An Authentication module 616 comprised by the Action Execution Layer 614 verifies and authorizes access to various external systems and tools for interaction with the real-world and other agents in the virtual world, including but not limited to Communication Platforms 618, Smart Home 620, Banking Systems 622, Property Management 624, and External Tools 626. All executed actions are recorded through an Action Logger module 628, maintaining comprehensive audit trails of system operations. The Execution Feedback 630 is sent back to the ATMAN digital twin 600 for refinement, updates, enhancements, and corrections, similar to the tethered mode shown in FIG. 5 and described herein above.

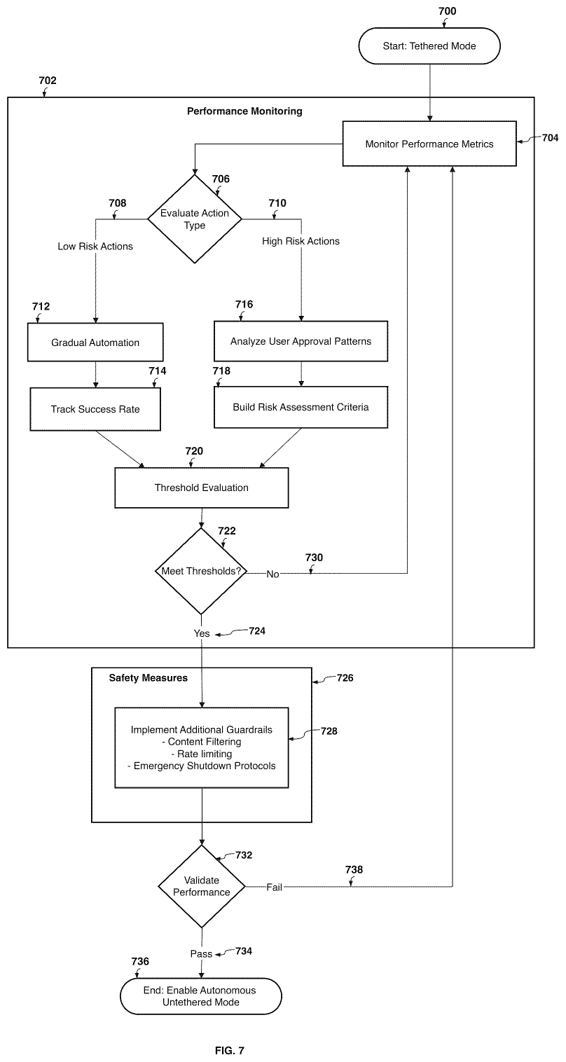

Referring now to FIG. 7, an illustration of a process for transitioning from tethered to autonomous untethered mode, is described in more detail. The transition process begins with the initial tethered operation 700, where the digital twin operates under direct user oversight. A Performance Monitoring subsystem 702 constantly monitors performance metrics of the digital twin at step 704 and evaluates action types at step 706. Low-risk actions 708 are routed for gradual automation at step 712. A Gradual Automation module 712 manages the incremental increase in autonomous capabilities and its freedom of interaction with the real-world through tools during a transition period. A success rate of these actions is tracked at step 714. For high-risk actions 710, the user approval patterns are analyzed at step 716 and a risk assessment criteria is created at step 718. The metrics from both low-risk and high-risk paths feed into a Threshold Evaluation module 720, which compares current performance against predetermined criteria for autonomous operation. Actions meeting the thresholds are routed to a Safety Measures subsystem 726.

A Safety Measures subsystem 726 implements additional guardrails 728 such as content filtering, rate limiting, and emergency shutdown protocols. A Validation subsystem 732 validates autonomous decisions against predicted user decisions, comprising pattern matching, historical analysis, and alignment verification. Upon successful validation 734, the system is transitioned to an autonomous untethered mode at step 736. Whereas, upon validation failure at step 738, the system continues its tethered mode where the performance metrics are monitored continuously at 704.

Each subsystem implements appropriate security and privacy controls, ensuring protection of user data throughout the transition process. The modular architecture enables independent scaling and updating of individual components while maintaining system integrity. The entire transition process is designed with security and safety as fundamental principles, implementing comprehensive controls at each stage to ensure reliable autonomous operation while maintaining alignment with user preferences and patterns.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A method for training and operating an artificial intelligence digital twin system with LLM agents, comprising:
collecting a plurality of multimodal data streams from a plurality of user devices;
processing the plurality of multimodal data streams through specialized data processing pipelines;
training a plurality of specialized artificial intelligence models using the processed multimodal data streams;
combining the plurality of specialized artificial intelligence models into an ensemble model architecture;
operating the ensemble model in a tethered mode; and
measuring one or more performance metrics of the ensemble model operating in the tethered mode; and
transitioning operating the ensemble model to an autonomous untethered mode responsive to achieving predetermined performance thresholds in the tethered mode.

2. The method of claim 1, wherein the multimodal data streams comprise data regarding at least one of:
use of external-facing tools;
text communications;
verbal interactions;
computational device interactions;
financial transactions; and
behavioral data.

3. The method of claim 1, wherein processing the multimodal data streams comprises:
converting the data into a standardized data format;
generating processed data by cleaning and normalizing the standardized data;
extracting one or more features for model training from the processed data through one or more of: text extraction, audio transcription, video processing, and image processing;
encrypting the processed data; and
storing the encrypted data in a distributed storage system.

4. The method of claim 1, wherein the plurality of specialized models comprises at least one of:
a language model trained on at least one of written communications and verbal interactions;
an audio model trained on vocal characteristics;
a video model trained on at least one of facial mannerisms and facial expressions; and
an image model trained on at least one of visual recognition and scene understanding.

5. The method of claim 1, wherein training the plurality of specialized artificial intelligence models comprises:
selecting one or more base models for each modality of data comprised by the plurality of multimodal data streams;
implementing custom training orchestration for each specialized artificial intelligence model of the plurality of specialized artificial intelligence models;
validating the performance of each specialized artificial intelligence model against one or more quality thresholds; and
implementing continuous learning capabilities based on user interactions with tools and it real-world environment.

6. The method of claim 1, wherein operating the ensemble model in the tethered mode comprises:
analyzing incoming requests through a multi-stage evaluation process;
classifying actions as one of low-risk or high-risk based on predetermined criteria;
approving low-risk actions automatically;
routing high-risk actions for user approval;
logging all model actions and model action outcomes; and
updating a behavior of the ensemble model based on the model action outcomes.

7. The method of claim 1, wherein transitioning to the autonomous untethered mode comprises:
generating a digital twin of the user;
operating the digital twin to interact with the ensemble model operating in the tethered mode;
verifying that the ensemble model operating in the tethered mode meets one or more performance thresholds responsive to at least two queries having different data modalities;
altering a classification of actions for low-risk actions and high-risk actions to result in a greater proportion of automatically approved low-risk actions over a transition period;
identify one or more user approval patterns for high-risk actions by analyzing a plurality of user decisions;
developing one or more risk assessment criteria based on the one or more user approval patterns;
confirming consistent alignment with at least one of one or more user preferences or one or more decision patterns;
implementing one or more additional safety guardrails for autonomous operation;
maintaining comprehensive action logging and monitoring capabilities; and
enabling autonomous operation upon meeting predetermined performance thresholds during the transition period.

8. A system for developing and deploying an artificial intelligence digital twin executed on a server comprising a processor, a network communication device, and a non-transitory computer-readable storage medium, the system comprising:
a data collection and storage subsystem configured to capture and process multimodal user data received from one or more data input streams;
a model training subsystem configured to develop specialized artificial intelligence models;
a decision-making framework configured to:
analyze incoming requests;
assess a risk level for each incoming request; and
route actions for approval for each incoming request responsive to the assessed risk level;
an action execution layer configured to:
authenticate the system with external systems;
implement approved actions; and
log execution outcomes; and
a learning and synchronization subsystem configured to:
receive and process user feedback;
update model behavior responsive to the received and processed user feedback; and
maintain an alignment of the system responsive to the received and processed user feedback.

9. The system of claim 8, wherein the data collection and storage subsystem comprises:
one or more data capture APIs for standardizing the one or more data input streams;
one or more specialized processing pipelines for processing data received from the one or more data input streams that is received in different data modalities; and
one or more encrypted distributed storage systems.

10. The system of claim 8, wherein the model training subsystem is configured to:
select and customize one or more base models for different input data modalities;
implement an ensemble model architecture;
maintain continuous learning capabilities; and
validate a performance of the ensemble model against one or more quality thresholds.

11. The system of claim 8, wherein the decision-making framework comprises:
an action analysis module for evaluating requests;
a risk assessment module for categorizing actions;
approval routing logic for different risk levels; and
feedback processing mechanisms for updating decision patterns.

12. A system for training and operating an artificial intelligence digital twin system with LLM agents, comprising:
a processor;
a network communication device positioned in communication with the processor and operable to communicate across a computerized network; and
a non-transitory computer-readable storage medium having store thereon software that, when executed by the processor, is operable to:
collect a plurality of multimodal data streams from a plurality of user devices;
process the plurality of multimodal data streams through specialized data processing pipelines;
train a plurality of specialized artificial intelligence models using the processed multimodal data streams;
combine the plurality of specialized artificial intelligence models into an ensemble model architecture;
operate the ensemble model in a tethered mode; and
measure one or more performance metrics of the ensemble model operating in the tethered mode; and
transition operating the ensemble model to an autonomous untethered mode responsive to achieving predetermined performance thresholds in the tethered mode.

13. The system of claim 12, wherein the multimodal data streams comprise data regarding at least one of:
use of external-facing tools;
text communications;
verbal interactions;
computational device interactions;
financial transactions; and
behavioral data.

14. The system of claim 12, wherein the software is operable to, when executed by the processor, process the multimodal data streams by:
converting the data into a standardized data format;
generating processed data by cleaning and normalizing the standardized data;
extracting one or more features for model training from the processed data through one or more of: text extraction, audio transcription, video processing, and image processing;
encrypting the processed data; and
storing the encrypted data in a distributed storage system.

15. The system of claim 12, wherein the plurality of specialized models comprises at least one of:
a language model trained on at least one of written communications and verbal interactions;
an audio model trained on vocal characteristics;
a video model trained on at least one of facial mannerisms and facial expressions; and
an image model trained on at least one of visual recognition and scene understanding.

16. The system of claim 12, wherein the software is operable to, when executed by the processor, train the plurality of specialized artificial intelligence models by:
selecting one or more base models for each modality of data comprised by the plurality of multimodal data streams;
implementing custom training orchestration for each specialized artificial intelligence model of the plurality of specialized artificial intelligence models;
validating the performance of each specialized artificial intelligence model against one or more quality thresholds; and
implementing continuous learning capabilities based on user interactions with tools and it real-world environment.

17. The system of claim 12, wherein the software is operable to, when executed by the processor, operate the ensemble model in the tethered mode by:
analyzing incoming requests through a multi-stage evaluation process;
classifying actions as one of low-risk or high-risk based on predetermined criteria;
approving low-risk actions automatically;
routing high-risk actions for user approval;
logging all model actions and model action outcomes; and
updating a behavior of the ensemble model based on the model action outcomes.

18. The system of claim 12, wherein the software is operable to, when executed by the processor, transition to the autonomous untethered mode by:
generating a digital twin of the user;
operating the digital twin to interact with the ensemble model operating in the tethered mode;
verifying that the ensemble model operating in the tethered mode meets one or more performance thresholds responsive to at least two queries having different data modalities;
altering a classification of actions for low-risk actions and high-risk actions to result in a greater proportion of automatically approved low-risk actions over a transition period;
identify one or more user approval patterns for high-risk actions by analyzing a plurality of user decisions;
developing one or more risk assessment criteria based on the one or more user approval patterns;
confirming consistent alignment with at least one of one or more user preferences or one or more decision patterns;
implementing one or more additional safety guardrails for autonomous operation;
maintaining comprehensive action logging and monitoring capabilities; and
enabling autonomous operation upon meeting predetermined performance thresholds during the transition period.
